(19) United States
(12) Patent Application Publication
(10) Pub. No.: US 2025/0036324 A1
(43) Pub. Date: Jan. 30, 2025

(54) PRINTING APPARATUS, METHOD OF CONTROLLING PRINTING APPARATUS, AND STORAGE MEDIUM

(71) Applicant: CANON KABUSHIKI KAISHA, Tokyo (JP)

(72) Inventor: Kazuhisa Fujino, Kanagawa (JP)

(21) Appl. No.: 18/746,175

(22) Filed: Jun. 18, 2024

(30) Foreign Application Priority Data
Jul. 25, 2023 (JP) 2023-120584

(51) Int. Cl. G06F 3/12

(52) U.S. Cl. CPC G06F 3/1205

(57) ABSTRACT

A printing apparatus includes: one or more processors and/or circuitry which function as: a reception unit configured to receive print jobs including setting information and job data, and being capable of receiving the setting information of at least one second print job while a first print job is executed, the second print job being different from the first print job; and a control unit configured to perform a continuous printing process on the second print job based on the setting information of the first print job and the received setting information of the second print job.

### BACKGROUND OF THE INVENTION

### Field of the Invention

The present disclosure relates to control for improving productivity in handling plural print jobs.

### Description of the Related Art

Printers perform control which, during image forming of a current page, feeds a print medium for the next page (hereinafter referred to as “continuous feed control”) in order to improve the printers' productivity. By this continuous feed control, print media are conveyed to the print head without long intervals, thus making it possible to continue printing without stopping the image forming process (see Japanese Patent Laid-Open No. JPH02-116571 (hereinafter referred to as “Document 1”)). The technique described in Document 1 relates to continuous feed control for a single print job, and does not take continuous feed control across plural print jobs into consideration. In a case where a printer has a large-capacity memory capable of saving plural print jobs, the printer can compare setting information of a currently printed print job and setting information of a print job to be printed next to perform continuous feed control across the plural print jobs.

### SUMMARY OF THE INVENTION

A printing apparatus according to the present disclosure includes: one or more processors and/or circuitry which function as: a reception unit configured to receive print jobs including setting information and job data, and being capable of receiving the setting information of at least one second print job while a first print job is executed, the second print job being different from the first print job; and a control unit configured to perform a continuous printing process on the second print job based on the setting information of the first print job and the received setting information of the second print job.

Further features of the present disclosure will become apparent from the following description of exemplary embodiments with reference to the attached drawings.

### BRIEF DESCRIPTION OF THE DRAWINGS

FIG. 1 is a perspective view of a printing apparatus;

FIG. 2 is a cross-sectional view illustrating a print medium conveyance path in the printing apparatus;

FIG. 3 is a diagram illustrating a hardware configuration of the printing apparatus;

FIG. 4 is a diagram illustrating a module structure of the printing apparatus;

FIG. 5 is a diagram illustrating a flow of data from a client terminal to the printing apparatus;

FIGS. 6A, 6B, and 6C are diagrams illustrating a print setting data structure;

FIG. 7 is a diagram showing the relationship of FIGS. 7A and 7B, and FIGS. 7A and 7B are flowcharts illustrating a processing flow in continuous feed control; and

FIG. 8 is a flowchart illustrating a processing flow in continuous feed control.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

### First Embodiment

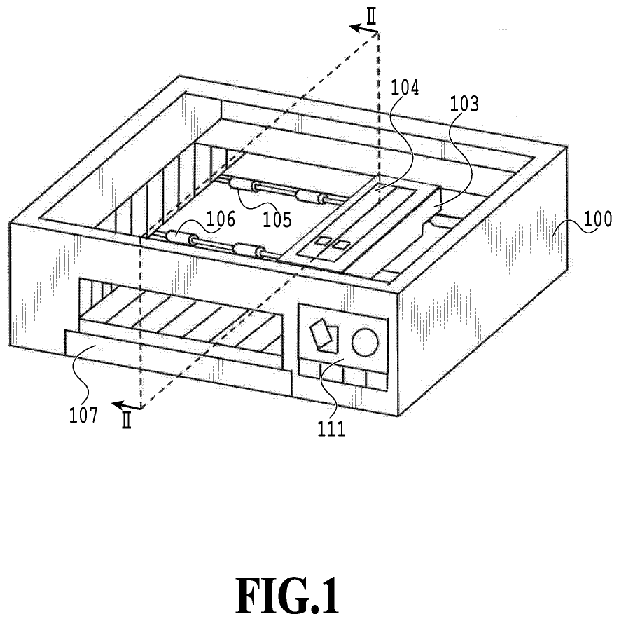

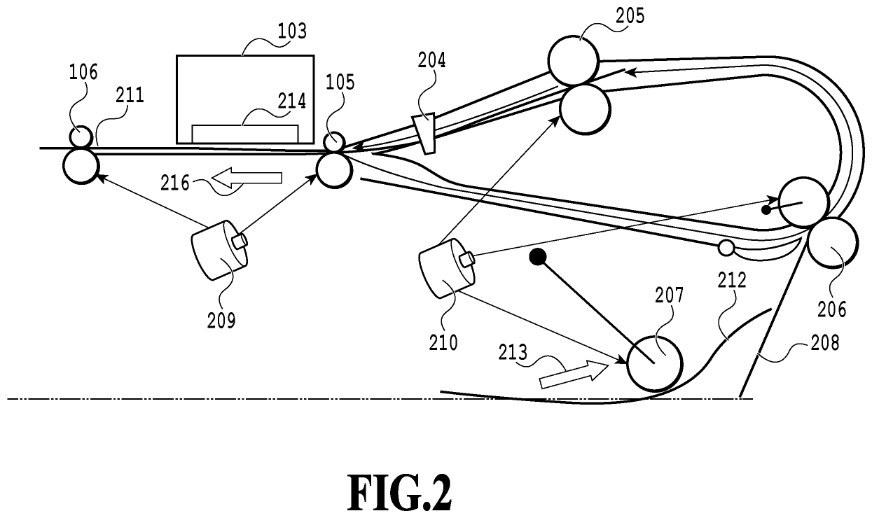

The present disclosure will be described below by taking an inkjet printing apparatus as an example. However, the present disclosure is not limited to this example. The present disclosure is also applicable to printing apparatuses of other types such as the electrophotographic type. FIG. 1 is a perspective view schematically illustrating an inkjet printing apparatus (hereinafter referred to also as “printing apparatus”) 100 in a first embodiment. FIG. 2 is a cross-sectional view of the printing apparatus 100 taken along the II-II plane, illustrating a configuration necessary for the present embodiment.

The printing apparatus 100 illustrated in FIG. 1 can be powered on and off and change print settings in response to the user's operations on an operation unit 111. The printing apparatus 100 can also notify the user on the liquid display unit of the operation unit 111 to notify the user of its status and prompt the user to perform processes. The printing apparatus 100 drives a sheet feed roller 207 by driving a sheet feed motor 210 to feed print media one by one from a sheet feed port 107 where print media can be loaded. A print medium 212 is conveyed along a cassette's inclined portion 208 to first intermediate rollers 206. Also, by driving the sheet feed motor 210, the printing apparatus 100 rotates the first intermediate rollers 206 and second intermediate rollers 205 in such directions as to convey the print medium in a conveyance direction 213. By driving a conveyance motor 209, the printing apparatus 100 rotates conveyance rollers 105 and sheet discharge rollers 106 so as to move a print medium 211 forward in a conveyance direction 216 and convey the print medium 211 to under a print head 214. The sheet feed roller 207, the first intermediate rollers 206, the second intermediate rollers 205, the conveyance rollers 105, and the sheet discharge rollers 106 are disposed in this order from the sheet feed port 107. In the present embodiment, there are three types of rollers that are driven by the sheet feed motor 210, but the number of rollers may be changed according to the length of the conveyance path or the length of the print medium to be handled. Moreover, the two-motor configuration with the sheet feed motor 210 and the conveyance motor 209 has been described above, but a mechanism that includes a single motor and switches the rollers to be driven may be employed. The printing apparatus 100 detects the print medium 211 conveyed by the second intermediate rollers 205 with a sheet detection sensor 204. After the detection, the printing apparatus 100 calculates the position of the leading edge of the print medium 211 from driving amounts of the sheet feed motor 210 and the conveyance motor 209. Then, the printing apparatus 100 ejects inks from the print head 214 while scanning a carriage 103 carrying the print head 214 and ink tanks 104 in a direction orthogonal to the conveyance direction of the print medium 211 to form an image on the print medium 211 (hereinafter this operation will be referred to as “printing”). The printing apparatus 100 is capable of driving the sheet feed motor 210 during the printing of the print medium 211 to feed the next print medium 212. Feeding the next print medium 212 during the printing of the print medium 211 fed before it improves the print speed.

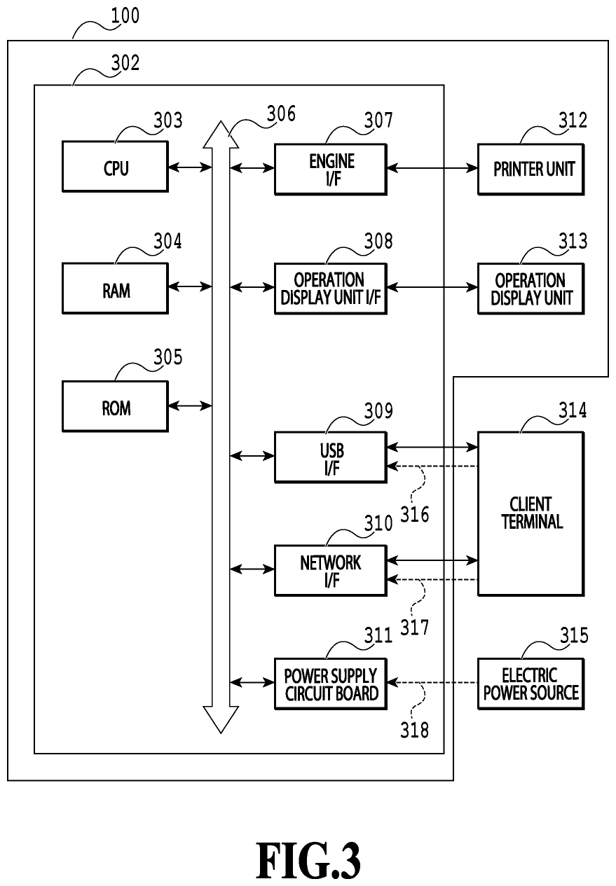

FIG. 3 is a block diagram illustrating a hardware configuration of the printing apparatus 100 in the present embodiment. Hardware elements of the printing apparatus 100 are connected by a control bus 306. A central processing unit (CPU) 303 inside a control unit 302 of the printing apparatus 100 loads control programs stored in a read-only memory (ROM) 305 to a random-access memory (RAM) 304 and reads them out on a timely basis to perform various kinds of control, such power-on control and print control. The RAM 304 is a primary memory for the CPU 303 and used as a work area and a temporary storage area to load the various programs stored in the ROM 305. The ROM 305 stores image data, the various programs, and various setting information. Also, in the present embodiment, the ROM 305 is considered to be a rewritable flash storage, an electrically erasable programmable read-only memory (EEPROM), or the like, but may be an auxiliary storage device such as a hard disk drive (HDD) or a solid state drive (SSD). Note that the printing apparatus 100 such that a single CPU 303 uses a single memory (RAM 304) to execute the processes in the later-described flowchart, but may employ other configurations. For example, the printing apparatus 100 can use plural CPUs in cooperation with plural RAMs, ROMs, and storages to execute the processes illustrated in the later-described flowchart. Alternatively, the printing apparatus 100 may use a hardware circuit to execute some of the processes. An engine interface (hereinafter referred to as “engine I/F”) 307 connects a printer unit (printing unit) 312 and the control unit 302. Image data to be printed by the printer unit 312 is transferred from the control unit 302 through the engine I/F 307 and printed on a print medium, such as paper, by the printer unit 312. An operation display unit I/F 308 connects an operation display unit 313 and the control unit 302. The operation display unit 313 includes a liquid crystal display unit with a touch panel function, operation keys, and the like, and functions as a reception unit that receives user instructions. A universal serial bus (USB) I/F 309 and a network I/F 310 control communication with a client terminal (information processing apparatus) 314 connected to the printing apparatus 100. A single client terminal 314 is connected to the printing apparatus 100 through the USB I/F 309. Plural client terminals 314 may be connected to the printing apparatus 100 through the network I/F 310. A power supply circuit board 311 transforms electric power supplied from an electric power source 315 through a power supply cable 318 and supplies the resulting electric power to the printing apparatus 100. Also, the power supply circuit board 311 may include a rechargeable battery capable of storing electric power.

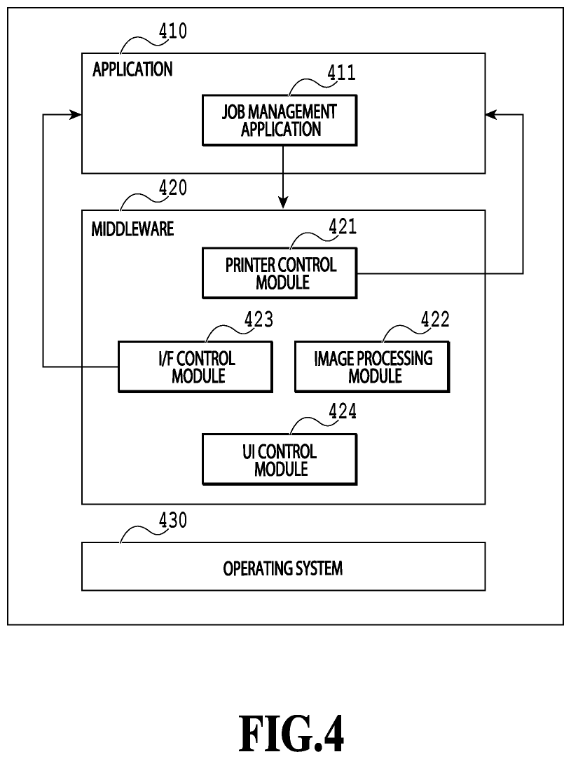

Next, a functional configuration of software to be run by the CPU 303 will be described. FIG. 4 is a diagram illustrating a software configuration of a control program loaded to the RAM 304 in the present embodiment for controlling hardware modules. The control program is divided into three blocks. The three blocks refer to an application layer 410 that manages an application, a middleware layer 420 that controls the printing apparatus 100 through the various I/Fs, and an operating system 430 that manages overall control.

The operating system 430 provides fundamental functions for the control unit 302 to execute the control program. The middleware layer 420 includes a software group that controls the printer unit 312 and I/Fs for physical devices. In the present embodiment, the middleware layer 420 includes the following four modules. There is a printer control module 421 as a module that controls the engine I/F 307. There is an I/F control module 423 that controls the USB I/F 309 and the network I/F 310, which are devices to be used for communication with the client terminal 314. There is an image processing module 422 that performs image data processing on image data received by the I/F control module 423 such that the printer control module 421 can print the image data. There is a UI control module 424 that controls the operation display unit I/F 308. The application layer 410 implements functions which the printing apparatus 100 provides to the user, such as printing, by causing devices to operate through the middleware. For example, in a case where the I/F control module 423 receives a print job from the network I/F 310, the reception of the print job is notified to the application layer 410. In response to the notification, a job management application 411 in the application layer 410 executes the print job. The job management application 411 also generates a log regarding whether the print job was successfully executed. In this way, it is possible to record a log on a per-print job basis. The job management application 411 uses the image processing module 422 in the middleware layer 420 to perform image processing on data received by the I/F control module 423 such that the printer control module 421 can process the data. The printer control module 421 receives the data subjected to the image processing by the image processing module 422 and executes a printing operation with the printer unit 312.

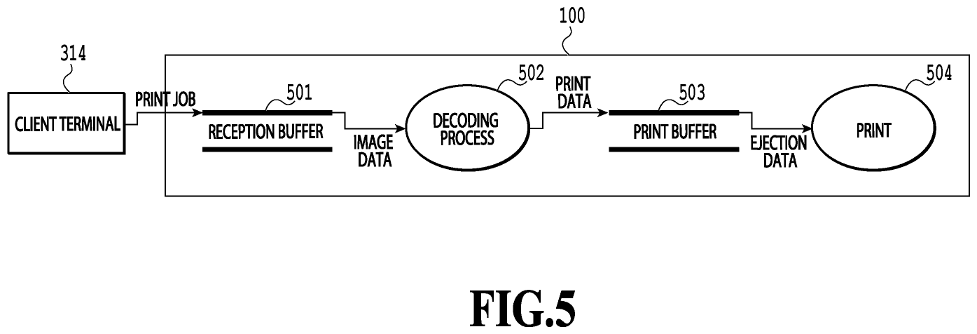

FIG. 5 is a diagram illustrating a flow of data in a print control flow. First, the user operates the client terminal 314 to execute a print job. Print job data is sent from the client terminal 314 to the printing apparatus 100 through a network line 317. The printing apparatus 100 receives this print job data through the network I/F 310. The received print job data is stored in a reception buffer 501 arranged in the RAM 304. The CPU 303 then performs a decoding process on the received data through the image processing module 422 according to the print job setting. In the decoding process, the image data in the received print job is converted into print data that supports ejection by the print head, and stored in a print buffer 503 arranged in the RAM 304. Based on the print data stored in the print buffer 503, the CPU 303 causes the print head 214 to eject inks onto a print medium through the printer control module 421, so that an image is printed on the print medium.

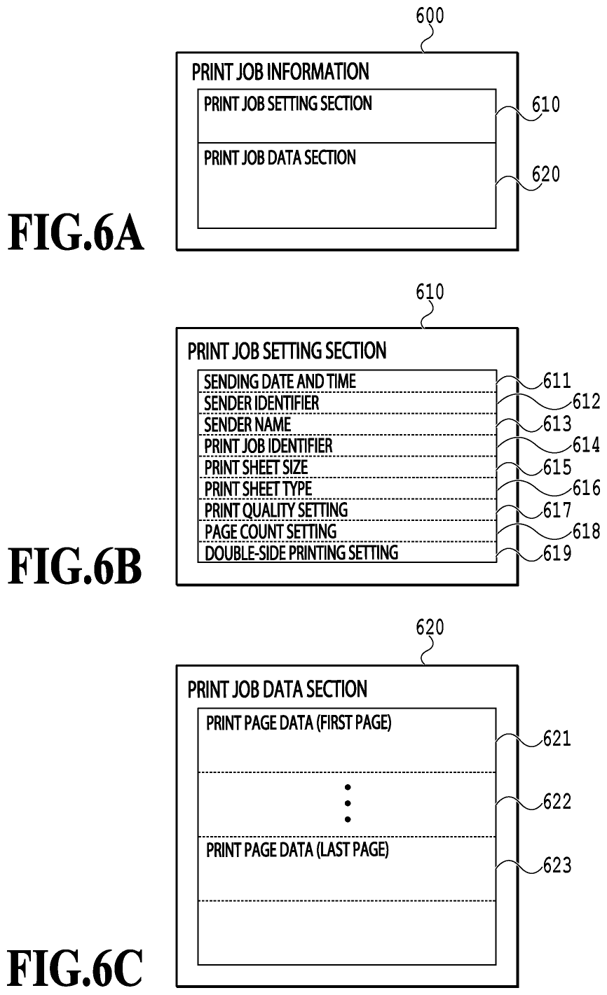

Next, details of print job information (print job) including a print job setting will be described with reference to FIGS. 6A, 6B, and 6C. FIGS. 6A, 6B, and 6C are diagrams illustrating a conceivable data structure of print job information in the present embodiment. FIG. 6A illustrates the entire structure. Print job information 600 includes a print job setting section 610 and print job data section 620. The print job setting section 610, which is data of only setting information of a print job, has a size of about several tens of kilobytes. The print job data section 620, which contains image data, may have a size of several megabytes. FIG. 6B is a diagram illustrating an example of the structure of the print job setting section 610. A sending date and time 611 represents the date and time on and at which the print job was sent from the sending source. As the date and time information, information indicating the year, month, date, hour, minute, and second is used, but time information in a smaller unit such as the millisecond may be included as necessary. The sending date and time 611 does not affect continuous feed determination control. In the present embodiment, continuous feed can be performed for print jobs even in a case where their sending dates and times are different as long as the time difference between the print jobs is such that one of the print job can be received during the printing of the other. A sender identifier 612 is an identifier uniquely identifying the user at the sending source. For example, the login name of the user or the like to the sending source device corresponds to the sender identifier 612. A sender name 613 is any character string used for purposes such as displaying the name of the user at the sending source. The sender identifier 612 and the sender name 613 do not affect the continuous feed determination control either. Even in a case where print jobs are sent from different users, the CPU 303 can still perform continuous feed control in a case where the other items in the print job setting are such that continuous feed can be performed.

A print job identifier 614 is an identifier uniquely identifying the print job information 600. In a case of canceling the print job with the client terminal 314, this print job identifier 614 is designated to cancel the print job. The print job identifier 614 does not affect the continuous feed determination control either. However, it is necessary to manage the data in the reception buffer 501 and the print buffer 503 so as to prevent a job with a different print job identifier 614 from being deleted at the time of the cancellation. In the present embodiment, to eliminate the need to manage the print job identifier 614 in the reception buffer 501 and the print buffer 503, the timing to start receiving the print job and the timing to start the decoding process are designated in the control flow.

A print sheet size 615 designates the sheet size for the print job. Specifically, the print sheet size 615 can be any one of the sizes of the print media handled by the printing apparatus 100, such as A4, A5, and a postcard size. A print sheet type 616 designates the sheet type of the print medium for the print job. Specifically, the print sheet type 616 can be any of the sheet types of the print media handled by the printing apparatus 100, such as plain paper, photographic paper, and envelope. Basically, in a case where the print media for the print jobs are the same in sheet type and sheet size, continuous feed control can be performed.

Depending on the printing apparatus 100, the sheets set in the sheet feed port of the printing apparatus 100 need to be changed in a case of handling different print sheet sizes or types. In the above case, the continuous feed may be impossible. On the other hand, in a case where the printing apparatus 100 has plural sheet feed ports and is configured to be capable of feeding a sheet from a second sheet feed port while performing printing on a sheet from a first sheet feed port, it is possible to perform continuous feed control even in the case of handling different print sheet sizes or types.

A print quality setting 617 designates the quality of the print job. Specifically, the print quality setting 617 can take a value such as fine, normal, or quick. In the case of feeding a sheet for a next page during printing, the subtle vibration of the sheet feed affects the printing. Thus, in the case of the fine setting, control without continuous feed is often performed. In the case of the normal or quick setting, continuous feed control, which involves feeding a sheet for a next page during printing, is typically performed. Also, with the fine setting, the number of times the carriage is reciprocally moved over the print medium (hereinafter referred to as “the number of the scanning”) during image forming is large as compared to the normal setting. Forming an image by reciprocally moving plural times brings about the effect of making image unevenness and misalignment less noticeable. For this reason, depending on the printing apparatus 100, the size of the print buffer 503 illustrated in FIG. 5 may be changed for the fine setting and the normal setting. In a case of a configuration that has only one print buffer 503 and changes its size to be provided according to the quality, the CPU 303 can determine that continuous feed control cannot be performed for jobs with different qualities.

A page count setting 618 designates the number of pieces of print page data contained in the print job data section 620. In the present embodiment, each print job setting includes the page count but may also include information as to whether there is a next page for each piece of print page data. For example, assume that two print jobs each including five pages are received. In this case, the CPU 303 determines whether continuous feed can be performed for the first to fifth pages in the first job with a single job setting and, if the continuous feed can be performed, executes continuous feed control. For the fifth page in the first job and the first page in the second job, the CPU 303 executes continuous feed control in a case of determining that continuous feed can be performed with the setting for the first job and the setting for the second job through the determination control in the present embodiment. For the first to fifth pages in the second job, the CPU 303 determines whether continuous feed can be performed with a single job setting and, if it the continuous feed can be performed, executes continuous feed control.

A double-side printing setting 619 is a setting as to whether to perform double-side printing for the print job. Specifically, the CPU 303 is capable of designating a one-side setting or a double-side setting. In the present embodiment, the CPU 303 determines that continuous feed can be performed only for the one-side printing setting. Nonetheless, the CPU 303 can determine that continuous feed can be performed even for the double-side setting in a case of a configuration capable of performing double-side printing by retaining plural sheets.

An example of settings not included in FIG. 6B will now be described. Firstly, there is a color/monochrome setting. This is a setting designating whether to use color inks for the printing or to use only a black ink for the printing. Changing the ink(s) to be used changes the nozzles in the print head 214 to be used, and therefore changes the size of the area to be used in the print buffer 503. Thus, as with the printing quality, the setting affects the determination of whether continuous feed control can be performed depending on the configuration of the print buffer 503.

Secondly, there is a manual double-side setting. With the double-side printing setting 619 described above, the printing apparatus 100 automatically flips the print medium after printing the front side and then prints the back side. On the other hand, in a case where the manual double-side setting is enabled, the user manually sets a sheet back into the sheet feed port again after one side is printed, and then the printing apparatus 100 prints the back side. In the present embodiment, the CPU 303 determines that continuous feed control cannot be performed in the case where the manual double-side setting is enabled since the user operation is required. The contents described above are examples. Not all of the above-described examples necessarily have to be included. Also, information other than the above can be included as well.

FIG. 6C is a diagram illustrating the print job data section 620. The print job data section 620 includes information of the piece(s) of print page data corresponds to the number designated by the page count setting 618. Pieces of print page data 621, 622, and 623 are each a piece of data indicating the content of printing to be performed. In a case of printing of a document, the print page data is text data or image data of each page forming the document. In a case of printing a photograph, the print page data is image data.

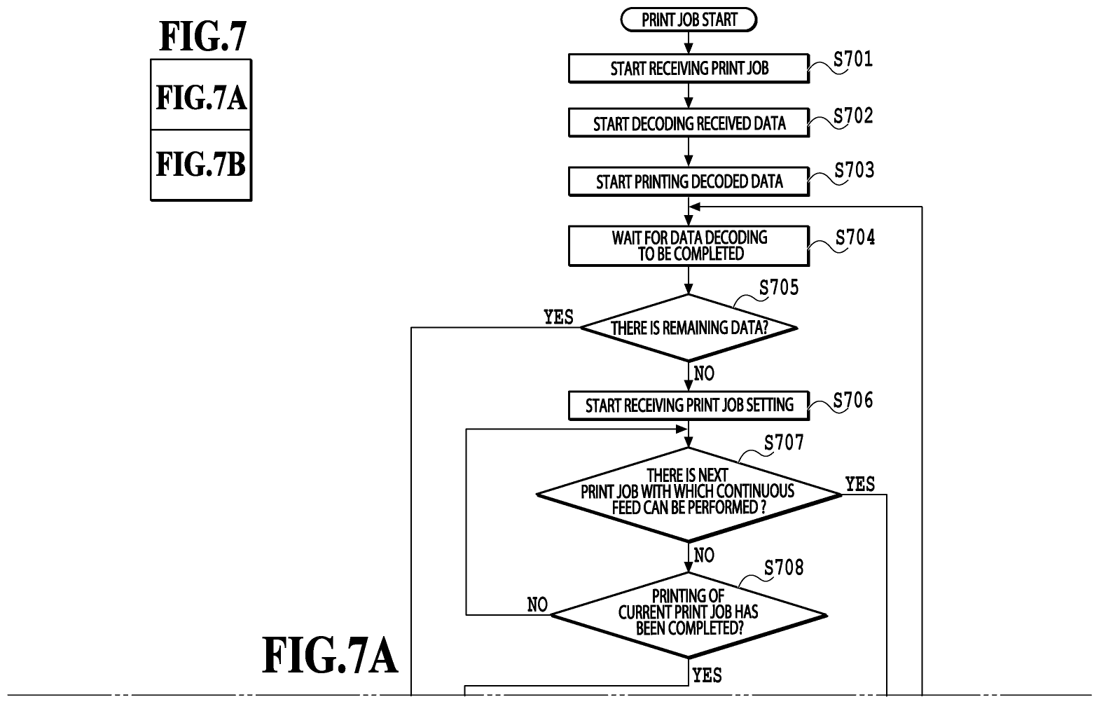

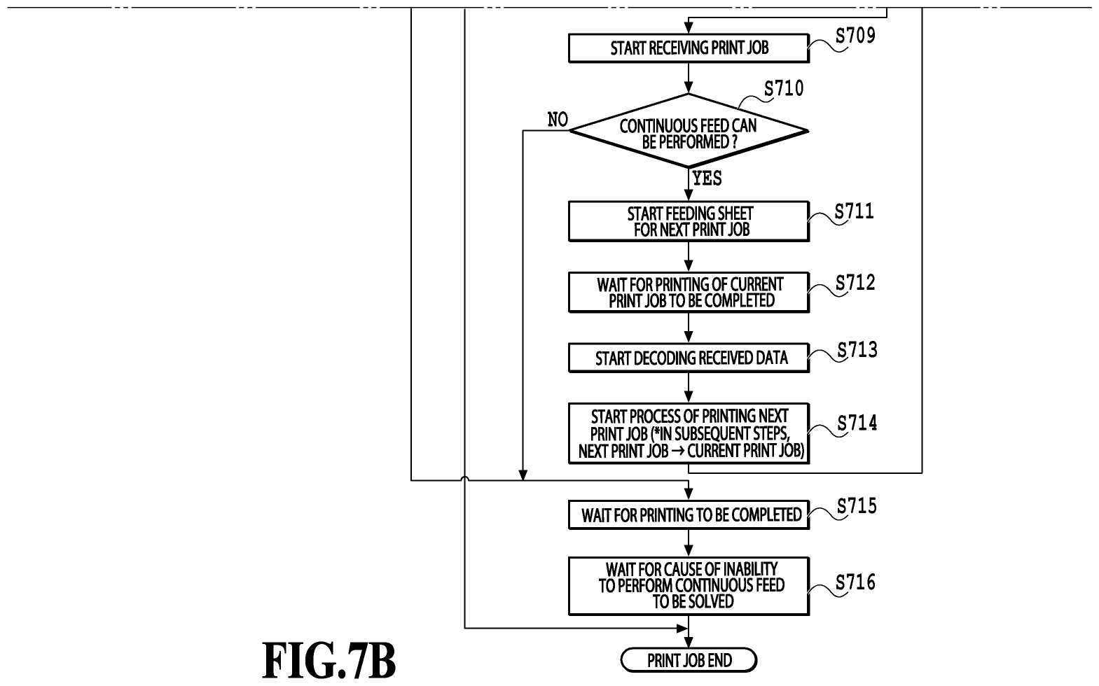

FIGS. 7A and 7B are flowcharts illustrating a print control flow assuming that print jobs are continuously input from the client terminal 314. The processing of this flowchart is executed in response to input of a print job from the client terminal 314 as a trigger. In S701, the CPU 303 receives a print job through the job management application 411 and the I/F control module 423, and the processing proceeds to S702. In a case where one or more print job settings have already been received at the time of receiving the print job in S701, the CPU 303 selects one print job from the received print job settings (pieces of print job setting information) and receives the print job. A conceivable situation where one or more print job settings have been received is the following case. Specifically, it is a case where print job settings have been received, but a predetermined operation, including replacement of a printing agent, such as the ink in an ink tank 104, needs to be performed due to the remaining amount of the printing agent running short or another similar incident, and the printer unit 312 has failed to execute the next print job. In a case of selecting one print job from one or more print job settings, the continuous feed processing illustrated in the sequence chart can be continued long in a case where a print job with which the number of print jobs to be subjected to continuous feed is largest is selected. Alternatively, simply, the print job received first may be printed.

In S702, in order to perform image processing on the print data of the print job received in S701 through the job management application 411 and the image processing module 422, the CPU 303 starts a decoding process on the received data. After starting the decoding process on the received data, the processing proceeds to S703. In S703, the CPU 303 instructs the printer unit 312 to start printing through the printer control module 421 in order to sequentially form an image that is based on the decoded data. After instructing the printer unit 312 to start printing, the processing proceeds to S704. In S704, the CPU 303 waits for the decoding of the received data to be completed through the job management application 411 and the image processing module 422. The printer unit 312 prints the print job also while the CPU 303 waits for the decoding of the received data to be completed. The processing proceeds to S705 after the decoding of the received data is completed.

In S705, the CPU 303 checks whether there is remaining data even after the completion of the decoding of the received data. As the examples in which the remaining data is existed, a case where there is remaining data include a case where the data of an irregular print job has been received, a case where the client terminal 314 has sent plural print jobs in a single communication, and so on are conceivable. Thus, the processing proceeds to S715 in a case where the remaining data is existed.

On the other hand, if there is no remaining data in S705 after the completion of the decoding of the received data, the processing proceeds to S706. In S706, the CPU 303 starts receiving the print job setting of the next print job from the client terminal 314 through the I/F control module 423. The printing apparatus 100 operates as follows to receive the print job setting from the client terminal 314. As illustrated in FIG. 6A, the print job setting section 610 is arranged at a portion of about 40 KB at the head of each print job. In a case where a print job is sent from a single client terminal 314, the CPU 303 firstly receives only the print job setting section 610 in the print job from this client terminal 314 and returns a negative acknowledgment (NAK) as a response to the print job to the client terminal 314. In a case where print jobs are sent from other client terminals 314 too, the CPU 303 of the printing apparatus 100 operates in a similar manner to receive one or more print job settings. The processing proceeds to S707 after starting receiving the print job setting of the next print job.

In the present embodiment, the CPU 303 waits for the decoding of the received data to be completed in S704. Thus, the CPU 303 receives the print job setting of the next print job after the reception buffer for the I/F control module 423 set in the RAM 304 becomes empty. This is advantageous in that the CPU 303 does not need to control the boundary between the print jobs in the reception buffer through the image processing module 422. In the present embodiment, the CPU 303 waits until the decoding of the received data is completed, and then starts receiving the print job setting. The reception buffer may be divided in advance and managed such that the CPU 303 manages the reception buffers for individual jobs through the I/F control module 423. Alternatively, instead of dividing the reception buffer, the CPU 303 may determine the boundary between the print jobs while performing the decoding through the image processing module 422.

In S707, while the printer unit 312 forms an image on a print medium, the CPU 303 checks whether there is a print job with which continuous feed can be performed among the one or more print job settings received in or after S706 through the job management application 411. In the present embodiment, a print job setting is the minimum information required to determine whether there is a print job with which continuous feed can be performed. Other data may be received as long as a print job setting is included. In particular, in a case where the configuration is such that there is enough space in the RAM 304 and a large reception buffer can be provided, the image data may be additionally received. The print job setting with which continuous feed can be performed will be described later.

The processing proceeds to S708 in a case where there is no next print job with which continuous feed can be performed in S707. The processing proceeds to S709 in a case where there is a next print job with which continuous feed can be performed. In S708, the CPU 303 checks whether the printing of the currently executed print job has been completed. The processing of the flowcharts illustrated in FIGS. 7A and 7B ends in a case where the printing of the currently executed print job has been completed. The processing returns to S707 in a case where the printing of the currently executed print job has not been completed.

In S709, the CPU 303 changes the response addressed to the client terminal 314 which sent the print job setting with which continuous feed can be performed through the job management application 411 and the I/F control module 423 as below. Up to this point, the CPU 303 has returned a NAK, indicating a prohibition to send the print job, as a response addressed to the client terminal 314. The CPU 303 now changes the response so as to return an acknowledgment (ACK) indicating a permission to send the print job. By returning an ACK, indicating a permission to send the print job, the CPU 303 can receive the subsequent data of the setting information of the next print job with which continuous feed can be performed (print job data section 620) from the client terminal 314. After starting receiving the print job data section 620 of the next print job with which continuous feed can be performed, the processing proceeds to S710.

In S710, the CPU 303 checks whether the printing apparatus 100 is in a state of being able to continue the printing and perform continuous feed through the job management application 411 and the printer control module 421. The CPU 303 determines that continuous feed cannot be performed in a case where any of the ink tanks 104 (printing agents) will need to be replaced after the completion of the currently executed print job or in a case where a predetermined operation such as a recovery operation for maintaining the ejection performance of the print head 214 (maintenance operation) will be needed after the completion of the currently executed print job. Note that the CPU 303 may determine that continuous feed can be performed in a case where the configuration is such that the inks can be refilled or the recovery operation for the print head 214 can be performed even if the sheet for the next page is fed. In a case where the CPU 303 determines in S710 that the printing apparatus 100 cannot perform continuous feed, the processing proceeds to S715. In a case where the CPU 303 determines that the printing apparatus 100 can perform continuous feed, the processing proceeds to S711.

In S711, the CPU 303 designates feed of a print medium in order to print the print job received in S709 through the job management application 411 and the printer control module 421. Note that the currently printed print job may include plural pages. In this case, the CPU 303 starts feeding a print medium in order to print the print job received in S709 at the start of printing of the last page in the currently printed print job. The processing proceeds to S712 after a print medium starts being fed. In S712, the CPU 303 waits for the currently printed print job to be completed. The processing proceeds to S713 after the currently printed print job is completed. Incidentally, in the present embodiment, the completion of a print job may not only be the completion of the currently performed printing operation but also include the completion of an analysis of the received print job. Usually, the analysis of a print job is completed before the completion of its printing operation. However, in a case where the received data contains data other than the print job information 600, that data need to be read and discarded, and the print job analysis may not be completed even after the printing on the print medium is completed in some cases. Reading and discarding the data can ensure free space in the reception buffer 501.

In S713, the CPU 303 starts a decoding process on the received data of the print job received in S709 through the job management application 411 and the printer control module 421. In the present embodiment, the decoding process for the received data of the next print job is started after the completion of the printing of the preceding print job. This is to avoid mixing of the data of the different print jobs in the print buffer set in the RAM 304 storing the decoded data (a print buffer mainly storing ejection data). Using a single buffer for data storage provides the effect of reducing the memory area to be used and the effect of simplifying the management of decoded data that needs to be read and discarded in a case where the client terminal 314 cancels job designation. In a case of a configuration with plural buffers for storing decoded data or a configuration capable of job management for decoded data as well, the CPU 303 may start the decoding process while receiving the print job in S709. After starting the decoding process on the received data, the processing proceeds to S714. In S714, the CPU 303 starts a process of printing the next print job through the job management application 411 and the printer control module 421 after the decoding of the received data progresses. The currently printed print job will now be expressed as “current print job”. The processing returns to S704 after starting the process of printing the next print job.

In S715, the CPU 303 waits for the currently printed print job to be completed. The processing proceeds to S716 after the currently printed print job is completed. In S716, the CPU 303 waits for the cause of the inability to perform continuous feed to be solved. After the cause of the inability to perform continuous feed is solved, the processing of the flowcharts illustrated in FIGS. 7A and 7B ends. In the present embodiment, the CPU 303 waits for the cause of the inability to perform continuous feed to be solved at the end of the processing of the flowcharts illustrated in FIGS. 7A and 7B, but may temporarily stop the print job and then perform the process of waiting for the cause of the inability to perform continuous feed to be solved. Then, after the cause of the inability to perform continuous feed is solved, the CPU 303 starts the process of S701 again.

In accordance with the present embodiment, a printer without a large-capacity memory for saving print jobs can keep track of the number of print jobs in the printer and receive print job settings from one or more client terminals to perform continuous feed control. Since the continuous feed control is performed without joining print jobs or the like, each print job's log is accurately recorded. Hence, the printer without a large-capacity memory for saving print jobs can perform appropriate continuous feed control.

### Second Embodiment

In the first embodiment, a one-to-many communication configuration in which the printing apparatus 100 is connected to plural client terminals 314 through the network line 317 has been described. As a second embodiment, an embodiment employing one-to-one communication in which the printing apparatus 100 is connected to a single client terminal 314 through a USB cable 316 will be described. In the first embodiment, a description has been given of control in which, due to the presence of plural users, cancellation does not involve removal of jobs sent by other users. On the other hand, in one-to-one communication, the effect of cancellation on removal of other print jobs is limited. This allows for control pursuing productivity. Specifically, in the first embodiment, the CPU 303 waits for the data decoding to be completed in S704 and then starts receiving the next job setting. In the second embodiment, on the other hand, the CPU 303 starts receiving the next print job setting without waiting for the data decoding to be completed. Also, in the first embodiment, the CPU 303 waits for the printing of the current print job to be completed in S712 and then starts decoding the data of the next print job. In the present embodiment, the CPU 303 starts decoding the data of the next print job without waiting for the printing of the current print job to be completed. Thus, in the present embodiment, different print jobs are allowed to be present together in the reception buffer 501 and the print buffer 503. This hastens the timing to start the processing and improves the productivity. The second embodiment will be described based on an example with connection through the USB cable 316, which implements physically one-to-one communication, but is also applicable to a communication method which handles plural jobs in a single session through the network line 317. In the present embodiment, in a case where plural jobs are included in a single session as above, the CPU 303 does not start receiving print jobs in a new session, and determines whether continuous feed can be performed with the next job in the currently received session.

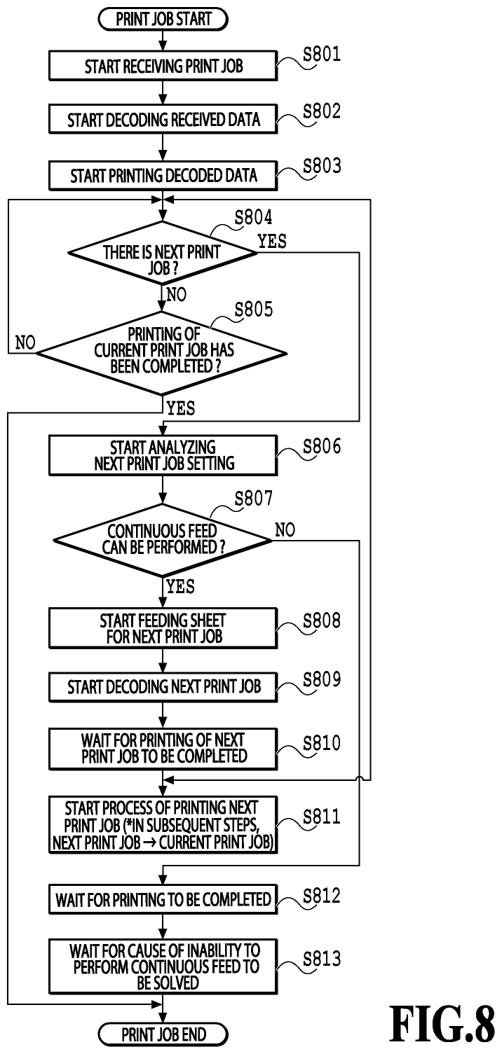

FIG. 8 is a flowchart illustrating a control flow explaining the present embodiment. It is a control flow assuming that different print jobs are continuously input from a single client terminal 314. In S801, the CPU 303 receives a print job through the job management application 411 and the I/F control module 423. While the present embodiment will be described based on a configuration that receives jobs one by one from the client terminal 314, the CPU 303 may select the optimal print job and process the job as in the first embodiment as long as the USB I/F 309 is configured to be capable of receiving one or more print jobs. The processing proceeds to S802 after the CPU 303 starts processing the print job. In S802, in order to perform image processing on the print data received in S801 through the job management application 411, the CPU 303 starts decoding the received print data through the image processing module 422. The processing proceeds to S803 after starting the decoding of the print data.

In S803, the CPU 303 starts printing the print job through the job management application 411 and the printer control module 421 in order to sequentially form the image of the decoded print data. The processing proceeds to S804 after the printing of the print job is started. In S804, the CPU 303 checks whether a next print job has been received from the client terminal 314 through the I/F control module 423. The processing proceeds to S805 in a case where no next print job has started being received. The processing proceeds to S806 in a case where a next print job has started being received. In S805, the CPU 303 checks whether the current print job has been completed through the job management application 411. In a case where the current job has not been completed, the processing returns to S804, in which the CPU 303 monitors whether a next print job has started being received through the I/F control module 423. In a case where the currently printed print job is completed in S805, the processing of the flowchart illustrated in FIG. 8 ends.

In S806, the CPU 303 starts analyzing the next print job setting received through the job management application 411. In the analysis of the print job setting, as described with reference to FIGS. 7A and 7B, the CPU 303 compares the print job setting of the currently printed print job and the print job setting of the print job received next to analyze whether continuous feed can be performed. The processing proceeds to S807 after starting analyzing the print job setting of the next print job. In S807, the CPU 303 determines whether continuous feed can be performed based on the results of the analysis in S806 and a state whether the remaining amount of any of the inks will run short or a recovery operation for the print head will be necessary after the completion of the currently printed print job. The processing proceeds to S812 in a case where it is determined in S807 that continuous feed cannot be performed. The processing proceeds to S808 in a case where it is determined in S807 that continuous feed can be performed.

In S808, the CPU 303 starts feeding a print medium in order to print the print job analyzed in S806 through the job management application 411 and the printer control module 421. The processing proceeds to S809 after a sheet for the next print job starts being fed. In S809, the CPU 303 starts decoding the print data through the image processing module 422 in order to print the next print job. In the first embodiment, a currently executed job is decoded and then the next print job is decoded in order to eliminate the need to distinguish the decoded print data of each job in the print buffer 503. In the present embodiment too, a similar waiting process may be inserted. The processing proceeds to S810 after starting the decoding of the print data of the next print job. In S810, the CPU 303 waits for the printing of the current print job to be completed. The processing proceeds to S811 after the printing of the current print job is completed. In S811, the CPU 303 starts a process of printing the next print job through the job management application 411 and the printer control module 421. The currently printed print job will now be expressed as “current print job”. The processing returns to S804 after starting the process of printing the next print job.

In S812, the CPU 303 waits for the currently printed print job to be completed through the job management application 411 and the printer control module 421. The processing proceeds to S813 after the currently printed print job is completed. In S813, the CPU 303 waits for the cause of the inability to perform continuous feed to be solved. After the cause of the inability to perform continuous feed is solved, the processing of the flowchart illustrated in FIG. 8 ends. Alternatively, in the case where it is determined in S807 that continuous feed cannot be performed with the job, the process of waiting for the cause of the inability to perform continuous feed to be solved in S813 is immediately terminated, and the printing of the next print job is started.

In accordance with the present embodiment, a printer without a large-capacity memory for saving print jobs can keep track of the number of print jobs in the printer and receive print job settings from client terminals to perform continuous feed control. Since the continuous feed control is performed without joining print jobs or the like, each print job's log is accurately recorded. Hence, the printer without a large-capacity memory for saving print jobs can perform appropriate continuous feed control.

### OTHER EMBODIMENTS

The present disclosure can also be implemented through processing including supplying a program for implementing one or more functions of the embodiments described above to a system or an apparatus by using a network or a storage medium, and reading and executing, by a computer of the system or the apparatus, the program. The computer includes one or a plurality of processors or circuits, and may include a network of a plurality of individual computers or a plurality of individual processors or circuits, to read and execute a computer-readable instruction.

The processor or circuit may include a central processing unit (CPU), a micro processing unit (MPU), a graphics processing unit (GPU), an application specific integrated circuit (ASIC), or a field-programmable gate array (FPGA). Moreover, the processor or circuit can include a digital signal processor (DSP), a data flow processor (DFP), or a neural processing unit (NPU).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-120584, filed Jul. 25, 2023, which is hereby incorporated by reference wherein in its entirety.

What is claimed is:

1. A printing apparatus, comprising one or more processors and/or circuitry which function as:
a reception unit configured to receive print jobs including setting information and job data, and being capable of receiving the setting information of at least one second print job while a first print job is executed, the second print job being different from the first print job; and
a control unit configured to perform a continuous printing process on the second print job based on the setting information of the first print job and the received setting information of the second print job.

2. The printing apparatus according to claim 1, wherein the setting information includes a type and size of a print medium.

3. The printing apparatus according to claim 1, wherein the continuous printing process starts feeding a print medium for the second print job while a final page in a printing process of the first print job is printed.

4. The printing apparatus according to claim 1, wherein the one or more processors and/or circuitry further function as a sending unit configured to:
in a case where the reception unit receives the second print job while the first print job is executed, send a response to an information processing apparatus being a sending source of the second print job after receiving the setting information of the second print job, the response indicating a negative acknowledgment to send the second print job; and
in a case where the continuous printing process can be performed, send a response to the information processing apparatus that sent the second print job with which the continuous printing process can be performed, the response indicating an acknowledgment to send the second print job.

5. The printing apparatus according to claim 1, wherein
the one or more processors and/or circuitry further function as an image processing unit configured to perform image processing on the job data of the print jobs, and
the image processing unit performs the image processing on image data of the second print job after a printing process of the first print job is completed.

6. The printing apparatus according to claim 1, wherein in a case where plural information processing apparatuses are connected to the printing apparatus, the reception unit starts receiving the job data of the second print job after processing of image data of the first print job is completed.

7. The printing apparatus according to claim 1, wherein in a case where a single information processing apparatus is connected to the printing apparatus, the reception unit starts receiving the job data of the second print job before processing of image data of the first print job is completed.

8. The printing apparatus according to claim 1, wherein the control unit does not perform the continuous printing process in a case where a predetermined operation is needed after a printing process of the first print job is completed.

9. The printing apparatus according to claim 8, wherein the predetermined operation is replacement of a printing agent.

10. The printing apparatus according to claim 8, wherein the predetermined operation is a maintenance operation for a printing unit.

11. The printing apparatus according to claim 1, wherein in a case where the setting information of a print job to be subjected to the continuous printing process is not received until a printing process of the first print job is completed, the control unit selects a print job whose number of continuous printing processes is largest in the setting information of the second print job, and performs the continuous printing process on the print job.

12. The printing apparatus according to claim 5, wherein the image processing unit performs the image processing on the image data of the second print job after analysis of the first print job is completed.

13. The printing apparatus according to claim 1, wherein in a case where a printing process based on another print job included in a same session has not been completed, the reception unit does not start receiving a print job in a new session, and the control unit executes the printing process based on the another print job.

14. A method of controlling a printing apparatus which exchanges data with an information processing apparatus, the method comprising:
in a reception unit configured to receive jobs including setting information and job data from the information processing apparatus, receiving the setting information of a second print job from the information processing apparatus while a first print job is executed; and
performing a continuous printing process on the second print job based on the setting information of the first print job and the received setting information of the second print job.

15. A non-transitory computer readable storage medium storing a program for causing a computer to perform a method of controlling a printing apparatus which exchanges data with an information processing apparatus, the method comprising:
in a reception unit configured to receive jobs including setting information and job data from the information processing apparatus, receiving the setting information of a second print job from the information processing apparatus while a first print job is executed; and
performing a continuous printing process on the second print job based on the setting information of the first print job and the received setting information of the second print job.
